(19) United States
(12) Patent Application Publication
(10) Pub. No.: US 2024/0150535 A1
(43) Pub. Date: May 9, 2024

(54) METHOD FOR PREPARING ASYMMETRIC WETTABLE POLYIMIDE FIBER-BASED PHOTOTHERMAL AEROGEL

(71) Applicant: Northwestern Polytechnical University, Xi'an (CN)

(72) Inventors: Qiuyu ZHANG, Xi'an (CN); Yafeng REN, Xi'an (CN); Miao TIAN, Xi'an (CN)

(73) Assignee: Northwestern Polytechnical University, Xi'an (CN)

(21) Appl. No.: 18/243,103

(22) Filed: Sep. 7, 2023

(30) Foreign Application Priority Data
Nov. 4, 2022 (CN) 202211376154.1

(51) Int. Cl. C08J 9/00; D01D 5/00

(52) U.S. Cl. CPC C08J 9/0085; C08J 9/0071; D01D 5/0038; C08J 2205/026; C08J 2333/24; D10B 2331/14

(57) ABSTRACT

A method for preparing an asymmetric wettable polyimide fiber-based photothermal aerogel is provided. The method includes the steps: uniformly mixing polyimide powder and a solvent, then, performing electrostatic spinning, and cutting an obtained fiber felt into pieces for later use; mixing the broken fibers, polyamic acid and tert-butyl alcohol, then, performing shearing to form a stable dispersion liquid for low-temperature directional freezing, and performing freeze-drying and high-temperature thermal imidization to obtain a polyimide fiber-based aerogel material; and soaking the above aerogel material in a hydrophilic monomer solution for a polymerization reaction, and then performing low-temperature directional freezing and freeze-drying to obtain a hydrophilic polyimide fiber-based aerogel. The aerogel is placed under light source irradiation, and dropwise coating is performed on an upper surface of the aerogel with a hydrophobic filler resin mixed solution to obtain the asymmetric wettable fiber-based photothermal aerogel.

### CROSS REFERENCE TO THE RELATED APPLICATIONS

This application is based upon and claims priority to Chinese Patent Application No. 202211376154.1, filed on Nov. 4, 2022, the entire contents of which are incorporated herein by reference.

### TECHNICAL FIELD

The present invention belongs to the field of design of aerogel structures, and particularly relates to a method for preparing an asymmetric wettable polyimide fiber-based photothermal aerogel.

### BACKGROUND

Global population growth, climate change, environmental pollution and other problems have exacerbated water shortages, leading to a severe water crisis for nearly 3 billion people. In the face of these challenges, there is an urgent need to develop an efficient and low-cost seawater desalination technology to reduce energy consumption and improve clean water production efficiency. A common reverse osmosis technology requires significant capital investment, a mature supply chain, and a reliable supply of high-grade energy to operate. Additionally, generated brine must also be properly managed, which greatly limits application of the reverse osmosis technology.

Interfacial solar evaporation is an emerging method that can use sunlight to sustainably desalinate water sources while achieving zero liquid discharge. In common studies, a two-dimensional material is employed to float at a water-air interface, where water is sucked into the porous material and heated by sunlight to achieve efficient evaporation. However, due to large heat loss, low internal porosity and other defects of the two-dimensional materials, an evaporation rate is low, and fresh water production is also reduced.

A polyimide three-dimensional aerogel is a new material with ultra-high porosity and low density, which has been widely applied in the fields of thermal insulation, pressure sensitive detection, energy storage, adsorption separation, etc. A photothermal aerogel for solar evaporation is obtained by using freeze-forming and freeze-drying technologies, and preparation of micron-scale macropores is achieved while a photothermal material is introduced in the process. Compared with the two-dimensional material, the polyimide three-dimensional aerogel has excellent mechanical strength, moreover, abundant benzene ring structures in molecular chains show ultraviolet aging resistance, a service life of the material is guaranteed, an energy utilization rate can be significantly improved, and an interfacial evaporation effect is enhanced. Furthermore, the high porosity ensures a heat insulating property of the material, and the problem of low surface temperature of the material caused by heat dissipation to a water body is further solved, such that zero energy input and high-quality water regeneration are achieved.

At present, polyimide is mostly prepared by using a sol-gel method, the internal porosity of the material is low, and sufficient water supply is difficult to ensure. The internal porosity of an aerogel prepared by using polyimide fibers as a framework is obviously improved, and crystal growth is controlled by using a directional freezing technology, such that vertical pore channels which are vertically through are formed in the material, and the problem of slow water delivery can be solved. However, the whole of a fiber-based photothermal aerogel without hydrophobic modification is hydrophilic, such that the surface of the material is covered with salt after precipitation of the salt during the evaporation process of brine, which blocks an effective intake of sunlight. Therefore, it is necessary to perform structural hydrophilic and hydrophobic regulation and modification on the material to ensure that the precipitated salt can be quickly washed by the brine while the brine is rapidly transported and diffused so as to achieve excellent salt deposition resistance of the photothermal aerogel.

### SUMMARY

In order to overcome the defects of the prior art, the present invention provides a method for preparing an asymmetric wettable polyimide fiber-based photothermal aerogel. The aerogel prepared by using the method has the characteristics of internal vertical water channels, high porosity, super-hydrophobicity on the surface and super-hydrophilicity on the rest, and has a significant effect on solving the problems of low evaporation rate, short service life and salt blockage.

The above technical objective of the present invention is implemented by employing the following technical solutions:

A method for preparing an asymmetric wettable polyimide fiber-based photothermal aerogel includes the following steps:
S1, mixing polyimide powder and a solvent under an action of stirring to form a uniform spinning solution, then, transferring the spinning solution into a disposable syringe for electrostatic spinning, and cutting an obtained fiber felt into broken fibers for later use after vacuum drying;
S2, mixing the broken fibers, polyamic acid and tert-butyl alcohol, then, performing shearing in a pulp refiner to form a stable dispersion liquid, pouring the dispersion liquid into a polytetrafluoroethylene mold, placing the mold on a low-temperature freezing table for directional freezing, and then performing freeze-drying and high-temperature thermal imidization to obtain a polyimide fiber-based aerogel material;
S3, wetting the polyimide fiber-based aerogel material prepared in step S2 by means of ethanol, then, soaking the wet polyimide fiber-based aerogel material in a hydrophilic monomer solution, performing a polymerization reaction under an oscillation condition, and then performing low-temperature freezing and freeze-drying to obtain a hydrophilic polyimide fiber-based aerogel; and
S4, placing the hydrophilic polyimide fiber-based aerogel prepared in step S3 under xenon lamp light source irradiation, performing dropwise coating on an upper surface of the hydrophilic polyimide fiber-based aerogel with a hydrophobic filler resin mixed solution, and achieving hydrophobic modification after the solvent is completely volatilized, thereby obtaining the asymmetric wettable fiber-based photothermal aerogel.

Furthermore, in step S1, polyimide is a product of imidization of polyamic acid, and an imidization reaction may be implemented by means of a reaction with triethylamine or heat treatment. The solvent is selected from N, N-dimethylformamide, N, N-dimethylacetamide, acetone, chloroform, dimethyl sulfoxide, acetonitrile, or any combination thereof, and a mass ratio of the polyimide powder to the solvent is 1-1.5:7.5-10. In addition, the time for the stirring may be 8-16 h. in the electrostatic spinning, the temperature of the electrostatic spinning may be 19-28° C., the humidity may be 30-50%, a rotating speed of a receiving drum may be 300-500 rpm, and a propelling speed may be 0.1-0.5 mL/h. A distance between a needle of the disposable syringe for electrostatic spinning and a receiver may be 8-20 cm, and voltages of positive and negative poles may be +10-14 kV and −1-5 kV respectively. The vacuum drying refers to treatment for 8-20 h at 80-100° C. under vacuum to remove the residual solvent.

Furthermore, in step S2, the polyamic acid is a precursor of the polyimide in step S1, and a preparation method thereof is as follows: making equimolar 4,4′-diaminodiphenyl ether and 3,3′,4,4′-biphenyl tetracarboxylic dianhydride be fully polymerized in a solvent N, N-dimethylformamide for 4-6 h, where a mass ratio of the product, polyamic acid, to the N,N-dimethylformamide solvent may be 1:5-10, and the polyamic acid dispersion liquid is then precipitated in water and dried to obtain polyamic acid powder. Additionally, a mass ratio of the broken fibers to the polyamic acid to the tert-butyl alcohol may be 0.1-0.6:0.1-0.6:1. A shearing speed for the shearing may be 10-15 k/min, and shearing time may be 15-30 min. In addition, the freezing mold is a polytetrafluoroethylene mold having a metallic copper bottom, which may be customized according to a shape of the required aerogel. During the low-temperature directional freezing, only metallic copper at the bottom of the mold is cooled, and the rest polytetrafluoroethylene portion is exposed to a normal temperature. A freezing temperature is −196° C. to −20° C., freezing time is 6-10 h, and freeze-drying time is 10-20 h. Additionally, conditions of the high-temperature thermal imidization are as follows: the reaction is performed for 1-2 h at 100° C., 200° C. and 300° C. respectively.

Furthermore, in step S3, manners and conditions of the low-temperature directional freezing and freeze-drying are the same as those in step S2. Additionally, the hydrophilic monomer solution is selected from a pyrrole monomer solution, a dopamine monomer solution or a combination thereof. A preparation method for the pyrrole monomer solution is as follows: weighing a pyrrole monomer, ultrapure water and a FeCl₃ ethanol solution (2.5%, w/w) according to a mass ratio of 0.1-0.5:10-50:5-25, and performing full ultrasonic mixing to obtain the pyrrole monomer solution, where in the case of the pyrrole monomer solution, a polymerization temperature is 15-30° C., and polymerization time is 4-8 h. A preparation method for the dopamine monomer solution is as follows: uniformly mixing a phosphate buffered solution with pH of 6.5-8.5 and dopamine hydrochloride under an action of stirring to obtain the dopamine monomer solution, where in the case of the dopamine monomer solution, a polymerization temperature is 15-30° C., and polymerization time is 18-24 h.

Furthermore, in step S4, the filler resin solution is preferably a black filler resin solution, which is obtained by ultrasonically mixing black filler and a Nafion resin solution at a mass ratio of 0.1-0.5:100, where the black filler is one or more of a carbon nanotube, graphene and carbon black. Additionally, the light source irradiation is xenon lamp light source irradiation, and simulated sunlight intensity is 1 kW/m².

According to the present invention, the aerogel with high porosity, internal vertical channels and hydrophobic surface is prepared by using directional freezing, in-situ coating and asymmetric hydrophilic and hydrophobic modification processes, and polyimide fibers serve as a framework material of the aerogel. The hydrophilic polymer is integrally coated by the aerogel and the vertical channels are conductive to rapid water transport. Moreover, in the black hydrophobic layer modified on the upper surface of the aerogel, the black filler can further improve photothermal conversion efficiency of the aerogel, improve an evaporation rate of the material, and the hydrophobic layer can block precipitation of salt, thereby solving the key problem that an evaporation rate is reduced due to coverage of salt on the surface of the material, and greatly prolonging a service life of the aerogel.

### BRIEF DESCRIPTION OF THE DRAWINGS

FIG. 1 is a scanning electron microscopy (SEM) image of an aerogel structure in example 1 of the present invention;

FIG. 2 is an evaporation mass change diagram of an aerogel in example 1 of the present invention; and

FIGS. 3A-3B are effect diagrams of salt deposition resistance of an aerogel in example 1 of the present invention.

### DETAILED DESCRIPTION OF THE EMBODIMENTS

To make the objectives, technical solutions, and advantages of the present invention clearer, the technical solutions of the present invention will be described in detail below in combination with accompanying drawings and examples. Apparently, the examples described are merely some examples rather than all examples of the present invention. All the other examples obtained by those of ordinary skill in the art based on the examples in the present invention without creative efforts shall fall within the protection scope of the present invention.

All experimental methods used in the examples below are conventional experimental methods unless otherwise specified, and all used reagents, methods and apparatuses are conventional reagents, methods and apparatuses in the technical field unless otherwise specified.

### Example 1

This example relates to preparation for an asymmetric hydrophobically-modified carbon nanotube polypyrrole-coated polyimide fiber-based aerogel

(1) 0.8 g of polyimide powder was taken to be mixed with 7.2 g of N,N-dimethylformamide solvent and was stirred for 10 h at a room temperature to completely dissolve the polyimide powder to obtain a light yellow spinning solution with a mass fraction of 10%. The spinning solution was transferred into a 10 mL syringe, a rotating speed of a receiver was set to be 450 rpm, a propelling speed was set to be 0.3 mL/h, a receiving distance was set to be 10 cm, and voltages of positive and negative poles were set to be +12 kV and −5 kV respectively. A fiber felt obtained by means of spinning was treated in a vacuum oven at 95° C. for 10 h, and was cut into pieces with scissors for later use after the residual solvent was removed.

(2) 0.024 g of broken polyimide fibers, 0.024 g of polyamic acid and 5.952 g of tert-butyl alcohol were taken and placed in a 50 mL centrifuge tube, shearing was performed for 15 min with a pulp refiner at a speed of 13 k/min, and an obtained shear fluid was transferred into a self-made polytetrafluoroethylene mold having a metallic copper bottom. Subsequently, the bottom of the mold was placed on a freezing table at a temperature of −20° C., the tert-butyl alcohol solvent was cooled and crystallized, crystals grew from bottom to top, and after being frozen for 8 h, the mold was transferred to a 20 Pa freeze dryer at a temperature of −20° C., and the white polyimide aerogel was finally obtained after 10 h. The white polyimide aerogel obtained above was placed in a muffle furnace, and was subjected to a thermal imidization reaction at constant temperatures of 100° C., 200° C. and 300° C. respectively for 1 h. During the process, the polyamic acid was converted into polyimide, and a polyimide fiber framework was subjected to physical crosslinking so as to finally obtain light yellow polyimide fiber-based aerogel.

(3) 15 g of a 2.5% FeCl₃ ethanol solution and 30 g of a 1% pyrrole aqueous solution were taken and mixed to prepare a pyrrole monomer solution, the aerogel obtained in step (2) was wetted with ethanol and then was placed in the pyrrole monomer solution for a polymerization reaction for 4 h at a room temperature of 20° C. under an oscillation condition. The obtained wet aerogel was washed with water, frozen and freeze-dried to obtain black hydrophilic polypyrrole-coated polyimide fiber-based photothermal aerogel.

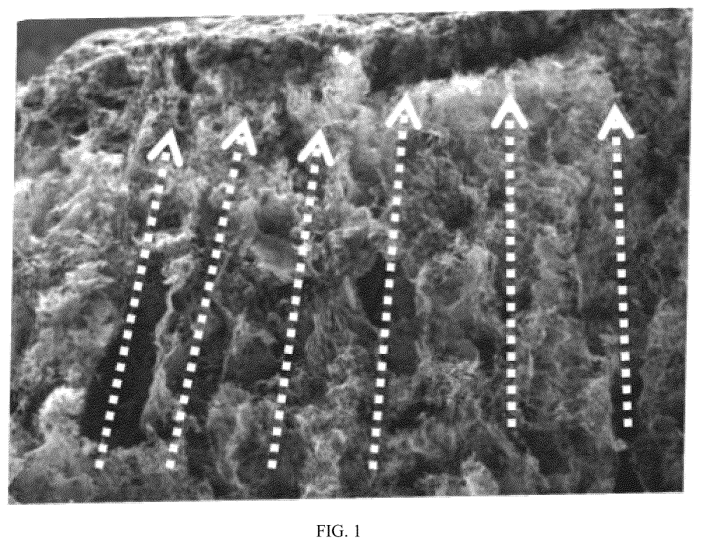

(4) 5 mg of a carbon nanotube and 5 g of a Nafion resin solution were weighed, and a carbon nanotube resin solution with a mass fraction of 0.1% was obtained under an ultrasonic action. The aerogel obtained in step (3) was placed under a xenon lamp light source with intensity of 1 kW/m², and the carbon nanotube resin solution was used for dropwise coating until the solvent was completely volatilized due to heating. A compact carbon nanotube hydrophobic composite film was generated on the surface of the aerogel, and finally the asymmetric hydrophobically-modified carbon nanotube polypyrrole-coated polyimide fiber-based aerogel was obtained. The structure of the aerogel is shown in FIG. 1, and dotted arrows in FIG. 1 indicate directional parallel channels formed after the directionally grown tert-butyl alcohol crystals are removed.

### Example 2

This example relates to preparation for an asymmetric hydrophobically-modified carbon nanotube polydopamine-coated polyimide fiber-based aerogel

(1) 1 g of polyimide powder was taken to be mixed with 7 g of dimethyl sulfoxide solvent and was stirred for 8 h at a room temperature to completely dissolve the polyimide powder to obtain a light yellow spinning solution with a mass fraction of 12.5%. The spinning solution was transferred into a 10 mL syringe, a rotating speed of a receiver was set to be 450 rpm, a propelling speed was set to be 0.3 mL/h, a receiving distance was set to be 10 cm, and voltages of positive and negative poles were set to be +13 kV and −4 kV respectively. A fiber felt obtained by means of spinning was treated in a vacuum oven at 95° C. for 10 h, and was cut into pieces with scissors for later use after the residual solvent was removed.

(2) 0.036 g of broken polyimide fibers, 0.036 g of polyamic acid and 5.928 g of tert-butyl alcohol were taken and placed in a 50 mL centrifuge tube, shearing was performed for 20 min with a pulp refiner at a speed of 14 k/min, and an obtained shear fluid was transferred into a self-made polytetrafluoroethylene mold having a metallic copper bottom. Subsequently, the bottom of the mold was placed on a freezing table at a temperature of −196° C., the tert-butyl alcohol solvent was cooled and crystallized, crystals grew from bottom to top, and after being frozen for 10 h, the mold was transferred to a 20 Pa freeze dryer at a temperature of −20° C., and the white polyimide aerogel was obtained after 10 h. The white polyimide aerogel obtained above was transferred into a muffle furnace, and was subjected to a thermal imidization reaction at constant temperatures of 100° C., 200° C. and 300° C. respectively for 1.5 h. During the process, the polyamic acid was converted into polyimide, and a polyimide fiber framework was subjected to physical crosslinking so as to obtain light yellow polyimide fiber-based aerogel.

(3) 10 mg of dopamine hydrochloride was taken and added into 20 g of a phosphate buffered saline with pH of 8.5, and a dopamine monomer solution was prepared under an action of stirring. The aerogel obtained in step (2) was wetted with ethanol and then was placed in the dopamine monomer solution for reaction for 24 h at a temperature of 25° C. under dark and oscillation conditions. The obtained wet aerogel was washed with water, frozen and freeze-dried to obtain black hydrophilic polyimide fiber-based photothermal aerogel.

(4) 15 mg of a carbon nanotube and 5 g of a Nafion resin solution were weighed, and a carbon nanotube resin solution with a mass fraction of 0.3% was obtained under an ultrasonic action. The aerogel obtained in step (3) was placed under a xenon lamp light source with intensity of 1 kW/m², and the carbon nanotube resin solution was used for dropwise coating until the solvent was completely volatilized due to heating. A compact carbon nanotube hydrophobic composite film was generated on the surface of the aerogel, and finally the asymmetric hydrophobically-modified carbon nanotube polydopamine-coated polyimide fiber-based aerogel was obtained.

### Example 3

This example relates to preparation for an asymmetric hydrophobically-modified carbon black polypyrrole-coated polyimide fiber-based aerogel

(1) 1.6 g of polyimide powder was taken to be mixed with 6.4 g of N,N-dimethylformamide solvent and was stirred for 10 h at a room temperature to completely dissolve the polyimide powder to obtain a light yellow spinning solution with a mass fraction of 20%. The spinning solution was transferred into a 10 mL syringe, a rotating speed of a receiver was set to be 300 rpm, a propelling speed was set to be 0.5 mL/h, a receiving distance was set to be 15 cm, and voltages of positive and negative poles were set to be +12 kV and −5 kV respectively. A fiber felt obtained by means of spinning was treated in a vacuum oven at 95° C. for 10 h, and was cut into pieces with scissors for later use after the residual solvent was removed.

(2) 0.012 g of broken polyimide fibers, 0.012 g of polyamic acid and 5.976 g of tert-butyl alcohol were taken and placed in a 50 mL centrifuge tube, shearing was performed for 30 min with a pulp refiner at a speed of 15 k/min, and an obtained shear fluid was transferred into a self-made polytetrafluoroethylene mold having a metallic copper bottom. Subsequently, the bottom of the mold was placed on a freezing table at a temperature of −80° C., the tert-butyl alcohol solvent was cooled and crystallized, crystals grew from bottom to top, and after being frozen for 8 h, the mold was transferred to a 20 Pa freeze dryer at a temperature of −20° C., and the white polyimide aerogel was finally obtained after 10 h. The white polyimide aerogel obtained above was transferred into a muffle furnace, and was subjected to a thermal imidization reaction at constant temperatures of 100° C., 200° C. and 300° C. respectively for 1 h. During the process, the polyamic acid was converted into polyimide, and a polyimide fiber framework was subjected to physical crosslinking so as to finally obtain light yellow polyimide fiber-based aerogel.

(3) 18 g of a 2.5% FeCl₃ ethanol solution and 30 g of a 1% pyrrole aqueous solution were taken and mixed to prepare a pyrrole polymerization solution, the aerogel obtained in step (2) was wetted with ethanol and then was placed in the pyrrole polymerization solution for reaction for 8 h at a room temperature of 20° C. under an oscillation condition. The obtained wet aerogel was washed with water, frozen and freeze-dried to finally obtain black hydrophilic polypyrrole-coated polyimide fiber-based photothermal aerogel.

(4) 25 mg of carbon black and 5 g of a Nafion resin solution were weighed, and a carbon black resin solution with a mass fraction of 0.1% was obtained under an ultrasonic action. The aerogel obtained in step (3) was placed under a xenon lamp light source with intensity of 1 kW/m², and the carbon black resin solution was used for dropwise coating until the solvent was completely volatilized due to heating. A compact carbon black hydrophobic composite film was generated on the surface of the aerogel, and finally the asymmetric hydrophobically-modified carbon black polypyrrole-coated polyimide fiber-based aerogel was obtained.

### Effect Test

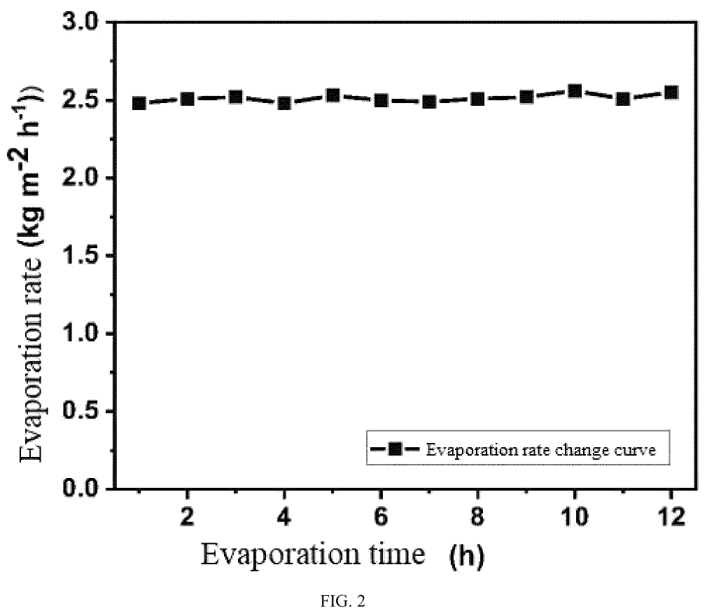

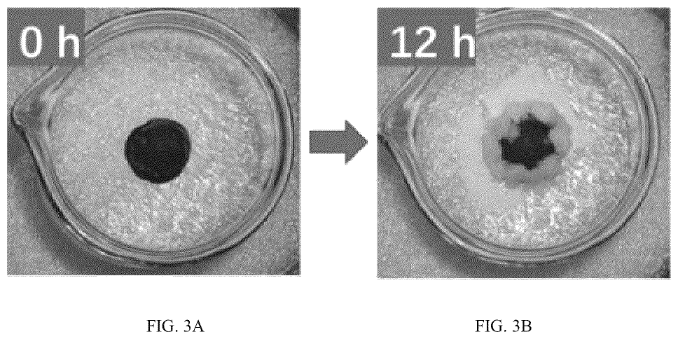

The asymmetric wettable polyimide fiber-based photothermal aerogel prepared in Example 1 was subjected to a photothermal water evaporation test and a salt deposition resistance effect test. Test results are shown in FIG. 2 and FIGS. 3A-3B respectively.

Water evaporation test method: a beaker was filled with a certain amount of brine, heat insulation polystyrene foam was placed above a water surface and at a certain height from the water surface, and non-woven fabric with the same bottom area as that of the aerogel was placed on an upper surface of the foam. A non-woven fabric roll was used for connecting the brine in the beaker with the non-woven fabric on the upper surface of the foam by means of a center of the polystyrene foam so as to achieve directional capillary transmission of the brine. The photothermal aerogel material was placed above the non-woven fabric, and an output current of an xenon lamp light source was adjusted to control illumination intensity on the surface of the aerogel. A four-digit analytical balance was used for recording the mass change situation of the bulk material under illumination, and a digital camera was used for recording the salt precipitation situation on the surface of the aerogel. The evaporation rate of the material was obtained by calculating a water evaporation amount per unit area per unit time.

Test results: the evaporation rate of the aerogel can be stabilized at 2.5 kg/(m²·h), which is higher than the evaporation rate of most photothermal materials. Improvement of this property is mainly attributed to coating of the hydrophilic polypyrrole on the aerogel skeleton, which improves the overall hydrophilicity of the material. The vertical structure generated by means of directional freezing ensures the directional rapid transmission of water, and additionally, a thermal insulation effect of the aerogel can concentrate heat on the surface of the material to reduce conduction loss to a water body. Introduction of the carbon nanotube on the surface of the aerogel greatly improves the visible light photothermal conversion performance of the material. Moreover, the 20% brine serves as the test water sample, the aerogel after a long time of evaporation for 12 h, no obvious salt is precipitated on the surface, indicating that modification of the hydrophobic composite layer on the surface of the material can effectively solve the problems of slow water transport caused by salt precipitation on the surface of the material and evaporation rate reduction due to less sunlight intake.

In conclusion, the asymmetric wettable polyimide fiber-based aerogel prepared by using the method of the present invention has a higher evaporation rate and salt deposition resistance. According to the present invention, the composite aerogel material with high porosity and vertical channels is prepared by using the directional freezing and surface hydrophobic modification processes. In addition, the hydrophobic layer on the surface of the aerogel can effectively prevent salt from being precipitated, and heat is concentrated on the surface of the material, such that the evaporation rate is further improved. This material has great significance for solving the problems of low evaporation rate and short service life of a traditional photothermal material.

What is claimed is:

1. A method for preparing an asymmetric wettable polyimide fiber-based photothermal aerogel, comprising the following steps:
S1, mixing a polyimide powder and a solvent under an action of stirring to form a uniform spinning solution, performing an electrostatic spinning on the uniform spinning solution to obtain a first resulting product, conducting a vacuum drying on the first resulting product to obtain an fiber felt, and cutting the fiber felt into broken fibers for later use;
S2, mixing the broken fibers, polyamic acid, and tert-butyl alcohol to obtain a second resulting product, performing a shearing on the second resulting product to form a stable dispersion liquid, pouring the stable dispersion liquid into a mold for a low-temperature directional freezing to obtain a third resulting product, and performing a freeze-drying and a high-temperature thermal imidization on the third resulting product to obtain a polyimide fiber-based aerogel material;
S3, wetting the polyimide fiber-based aerogel material by ethanol, soaking a wet polyimide fiber-based aerogel material in a hydrophilic monomer solution, performing a polymerization reaction on a soaked polyimide fiber-based aerogel material under an oscillation condition to obtain a fourth resulting product, and performing the low-temperature directional freezing and the freeze-drying on the fourth resulting product to obtain a hydrophilic polyimide fiber-based aerogel; and
S4, placing the hydrophilic polyimide fiber-based aerogel under a light source irradiation, performing a dropwise coating on an upper surface of the hydrophilic polyimide fiber-based aerogel with a hydrophobic filler resin mixed solution, and completely volatilizing a solvent of the hydrophobic filler resin mixed solution to obtain the asymmetric wettable polyimide fiber-based photothermal aerogel.

2. The method according to claim 1, wherein in step S1, the solvent is selected from N,N-dimethylformamide, N,N-dimethylacetamide, acetone, chloroform, dimethyl sulfoxide, acetonitrile or a combination thereof, and a mass ratio of the polyimide powder to the solvent is 1-1.5:7.5-10.

3. The method according to claim 1, wherein in step S1, a time for the stirring is 8-16 h, in the electrostatic spinning, a temperature of the electrostatic spinning is 19-28° C., a humidity is 30-50%, a rotating speed of a receiving drum is 300-500 rpm, a propelling speed is 0.1-0.5 mL/h, a distance between a needle of a disposable syringe for the electrostatic spinning and a receiver is 8-20 cm, voltages of positive and negative poles are +10-14 kV and −1-5 kV respectively, and the vacuum drying refers to a treatment for 8-20 h at 80-100° C. under a vacuum to remove a residual solvent.

4. The method according to claim 1, wherein in step S2, a mass ratio of the broken fibers to the polyamic acid to the tert-butyl alcohol is 0.1-0.6:0.1-0.6:1.

5. The method according to claim 1, wherein in step S2, the mold is a polytetrafluoroethylene mold having a metallic copper bottom, during the low-temperature directional freezing, the mold is placed on a surface of a low-temperature freezing table, only the metallic copper bottom is cooled, a rest polytetrafluoroethylene portion is exposed to a normal temperature, a freezing temperature is −196° C. to −20° C., a freezing time is 6-10 h, and a freeze-drying time is 10-20 h.

6. The method according to claim 1, wherein in step S3, the hydrophilic monomer solution is selected from a pyrrole monomer solution, a dopamine monomer solution, or a combination thereof, when the hydrophilic monomer solution is the pyrrole monomer solution, a polymerization temperature is 15-30° C., a polymerization time is 4-8 h, and when the hydrophilic monomer solution is the dopamine monomer solution, a polymerization temperature is 15-30° C., and a polymerization time is 18-24 h.

7. The method according to claim 1, wherein in step S4, the hydrophobic filler resin mixed solution is a black filler resin solution.

8. The method according to claim 7, wherein the black filler resin solution is obtained by ultrasonically mixing a black filler and a Nafion resin solution at a mass ratio of 0.1-0.5:100.

9. The method according to claim 8, wherein the black filler is one or more of a carbon nanotube, graphene, and a carbon black.

10. The method according to claim 1, wherein in step S4, the light source irradiation is a xenon lamp light source irradiation, and a simulated sunlight intensity is 1 kW/m².
